(19) United States
(12) Patent Application Publication
(10) Pub. No.: US 2011/0044745 A1
(43) Pub. Date: Feb. 24, 2011

(54) IMAGE FORMING APPARATUS AND IMAGE FORMING METHOD

(75) Inventors: Hidehiro TAKANO, Matsumoto (JP); Satoshi CHIBA, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/851,967

(22) Filed: Aug. 6, 2010

(30) Foreign Application Priority Data
Aug. 20, 2009 (JP) 2009-190942

(51) Int. Cl. G03G 15/00

(52) U.S. Cl. 399/400

(57) ABSTRACT

An image forming apparatus includes a transfer belt onto which an image is transferred, a roller around which the transfer belt is wound, a transfer roller that sandwiches the transfer belt with the belt driving roller, a transfer medium transporting unit, a guide portion, and a fixing unit. The transfer roller is arranged to form a transfer nip with the roller, and transfers the image from the transfer belt to a transfer medium. The transfer medium transporting unit vertically upwardly sucks the transfer medium, and transports the transfer medium with the image facing vertically down. The guide portion vertically upwardly sucks the transfer medium transported by the transfer medium transporting unit. The fixing unit has a heating roller and a pressing roller to form a fixing nip, and fixes the image guided by the guide at the fixing nip.

### CROSS-REFERENCE TO THE RELATED APPLICATIONS

This application claims priority to Japanese Patent Application No. 2009-190942 filed on Aug. 20, 2009. The entire disclosure of Japanese Patent Application No. 2009-190942 is hereby incorporated herein by reference.

### BACKGROUND

1. Technical Field

The present invention relates to an image forming apparatus and an image forming method in which an image is formed by developing a latent image formed on a photosensitive body by using a liquid developer that is formed by toner and carrier, transferring the developer to a transfer medium such as a print sheet, transporting the transfer medium by using a transport mechanism, and melting a toner image formed on the medium transferred by using the developer so as to be fixed.

2. Related Art

Generally, in image forming apparatuses that form a developed image and transfer the developed image to a transfer medium such as a print sheet, various transfer medium transporting mechanisms for transporting the transfer medium are built. As such a transfer medium transporting mechanism, a structure in which the transfer medium is transported to a fixing unit in accordance with movement of a transport belt in the state being attached to the belt by using an air suction force through a plurality of suction holes is known. As an example of such a transfer medium transporting mechanism. Japanese Patent Application Publication No. 6-135613 discloses such transfer medium transporting mechanism as an example.

In Japanese Patent Application Publication No. 6-135613, as a sheet transporting device of a copier that transports a sheet by attaching the sheet to a transport belt by using suction with negative pressure through a plurality of suction openings, a sheet transporting device of an image forming apparatus in which control valves each performing a valve operation such that a valve-open state is formed by the weight of the sheet in the transport process when the sheet passes on the suction holes and a valve-close state is formed at the other time are disposed in the suction holes is disclosed.

Generally, a transfer unit, which is used for transferring an image to a transfer medium, transfers an image to the transfer medium between a nip that is formed between two rollers. However, in such a case, when the transfer medium passes through the nip, curling of the transfer medium or the like may occur. This phenomenon markedly occurs if one of the two rollers forming the nip is a soft roller and the other is a hard roller or the like.

If the transfer medium in which the above-described curling is formed is transported by a general sheet transporting device, the transfer medium is not attached to the transport belt. Because no suction applies to the transfer medium in order to prevent the curling, the transfer medium is transported in a transport process in a state in which the transfer medium is lifted or separate from the transport belt. Then, when the transport of the transfer medium is performed in such a state, a trouble of the transfer medium dropping out from the transport belt during the transport process occurs, or the transfer medium cannot be transported to a predetermined position of the fixing unit. In other words, in an image forming apparatus including a general sheet transporting device, there are problems in that jamming according to the transfer medium dropping out during the transport process occurs, or defective fixing due to defective transportation of the transfer medium to the predetermined position of the fixing unit and deterioration of the image quality due to the defective fixing occur.

### SUMMARY

An advantage of some aspects of the invention is to provide an image forming apparatus and an image forming method. According to one object of the present disclosure, there is provided an image forming apparatus. The image forming apparatus includes a transfer belt onto which an image is transferred, a belt driving roller around which the transfer belt is wound, a transfer roller, a transfer medium transporting unit, a guide portion, and a fixing unit. The transfer roller sandwiches the transfer belt with the belt driving roller, is arranged to form a transfer nip, and transfers the image from the transfer belt to a transfer medium passing through the transfer nip. The transfer medium transporting unit vertically upwardly sucks the transfer medium to which the image is transferred, and transports the transfer medium with the image facing vertically down. The guide portion vertically upwardly sucks the transfer medium transported by the transfer medium transporting unit. The fixing unit that has a heating roller and a pressing roller to form a fixing nip, and fixes the image to the transfer medium at the fixing nip.

### BRIEF DESCRIPTION OF THE DRAWINGS

The invention will be described with reference to the accompanying drawings, wherein like numbers reference like elements.

FIG. 1 is a diagram illustrating an image forming apparatus including major constituent elements according to an embodiment of the invention.

FIG. 2 is a perspective view of the secondary transfer roller that is used in an image forming apparatus according to an embodiment of the invention.

FIGS. 3A to 3D are diagrams illustrating the operation of a transfer medium gripping mechanism of a secondary transfer roller used in an image forming apparatus according to an embodiment of the invention.

FIG. 4 is a diagram illustrating the operation of a transfer medium transporting unit used in an image forming apparatus according an embodiment of the invention.

FIG. 5 is a diagram illustrating the operation of a transfer medium transporting unit used in an image forming apparatus according an embodiment of the invention.

FIG. 6 is a schematic diagram showing control blocks of an image forming apparatus according to an embodiment of the invention.

FIG. 7 is a schematic diagram showing a transfer medium that passes through the secondary transfer nip.

FIG. 8 is a diagram illustrating a case where it is difficult for the front end to be sucked into a nip of a fixing unit due to curling of a transfer medium.

FIG. 9 is a diagram showing a control table of an airflow generating unit according to the type of a transfer medium.

FIG. 10 is a diagram showing an example of the control sequences performed by control blocks of an image forming apparatus according to an embodiment of the invention.

FIG. 11 is a diagram illustrating the dispositional relationship of constituent members relating to a second suction device.

### DETAILED DESCRIPTION OF EXEMPLARY EMBODIMENTS

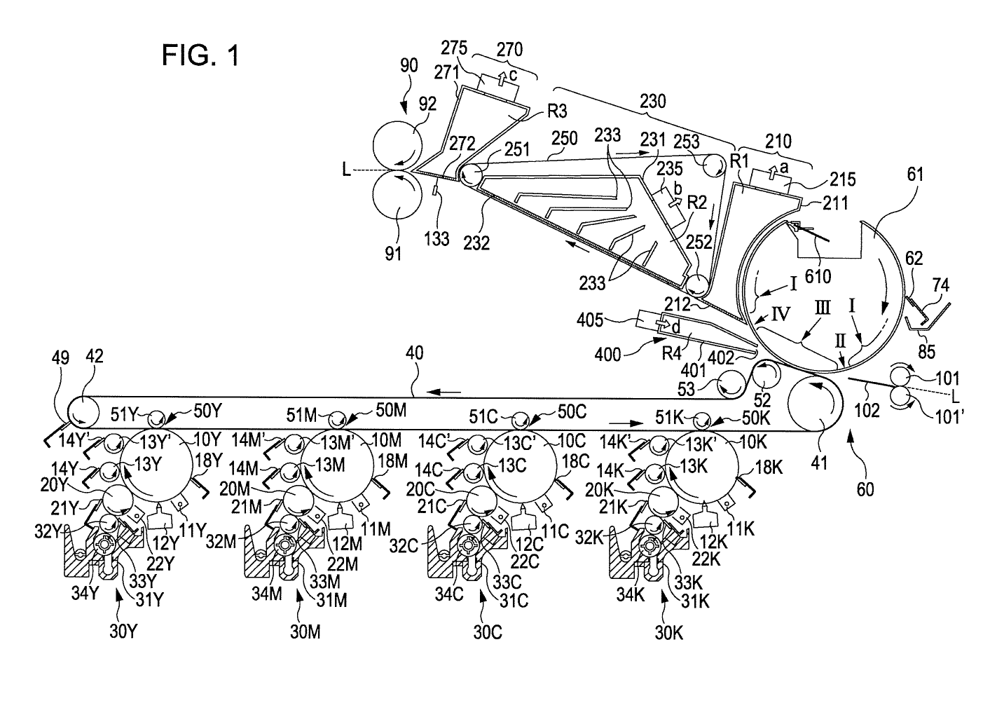

Hereinafter embodiments of the invention will be described with reference to the accompanying drawings. FIG. 1 is a diagram illustrating an image forming apparatus including major constituent elements according to an embodiment of the invention. In image forming units of colors that are disposed in the center portion of the image forming apparatus, developing devices 30Y, 30M, 30C, and 30K are disposed in the lower portion of the image forming apparatus, and the constituent members such as a transfer belt 40, a secondary transfer unit (secondary transfer unit) 60, and a fixing unit (fixing device) 90 are disposed in the upper portion of the image forming apparatus. In particular, by arranging the layout of the fixing unit 90 above the transfer belt 40, the installation area of the entire image forming apparatus can be suppressed. In this embodiment, a transfer medium, such as a paper sheet, that goes through the secondary transfer in the secondary transfer unit 60 is configured to be transported to the fixing unit 90 while the transfer medium is sucked by a transfer medium transporting device 230, suction devices 210 and 270, and the like, whereby such a layout can be realized.

The developing devices 30Y, 30M, 30C, and 30K include photosensitive bodies 10Y, 10M, 10C, and 10K, corona chargers 11Y, 11M, 11C, and 11K, exposure units 12Y, 12M, 12C, and 12K such as LED arrays, and the like for forming an image by using toner. The photosensitive bodies 10Y, 10M, 10C, and 10K are uniformly charged by the corona chargers 11Y, 11M, 11C, and 11K. Exposure processes are performed by the exposure units 12Y, 12M, 12C, and 12K based on an input image signal. Electrostatic latent images are formed on the charged photosensitive bodies 10Y, 10M, 10C, and 10K.

The developing devices 30Y, 30M, 30C, and 30K mainly include developing rollers 20Y, 20M, 20C, and 20K, developer containers (reservoirs) 31Y, 31M, 31C, and 31K that store liquid developers of colors including yellow (Y), magenta (M), cyan (C), and black (K) therein, and anilox rollers 32Y, 32M, 32C, and 32K that are coating rollers coating the developer rollers 20Y, 20M, 20C, and 20K with the liquid developers of the colors from the developer containers 31Y, 31M, 31C, and 31K. The developing devices 30Y, 30M, 30C, and 30K develop the electrostatic latent images formed with the liquid developers of the colors on the photosensitive bodies 10Y, 10M, 10C, and 10K.

The transfer belt 40 is an ring-shaped belt. The transfer belt 40 is stretched around a driving roller 41 and tension rollers 42, 52, and 53 and is driven to be rotated by the driving roller 41 while being brought into contact with the photosensitive bodies 10Y, 10M, 10C, and 10K in the primary transfer units 50Y, 50M, 50C, and 50K. In the primary transfer units 50Y, 50M, 50C, and 50K, primary transfer rollers 51Y, 51M, 51C, and 51K are disposed to face the photosensitive bodies 10Y, 10M, 10C, and 10K with the transfer belt 40 interposed therebetween. The primary transfer units 50Y, 50M, 50C, and 50K sequentially transfer toner images of the colors, which are developed on the photosensitive bodies 10Y, 10M, 10C, and 10K by using contact positions with the photosensitive bodies 10Y, 10M, 10C, and 10K as transfer positions, onto the transfer belt 40 in an overlapping manner, thereby forming a full-color toner image.

In a secondary transfer unit 60, a secondary transfer roller 61 is disposed to face a belt driving roller 41 with the transfer belt 40 interposed therebetween. In addition, a cleaning device that is formed by a secondary transfer roller cleaning blade 62 is disposed. In a transfer position in which the secondary transfer roller 61 is disposed, a monochrome toner image or a full-color toner image that is formed on the transfer belt 40 is transferred to a transfer medium such as a paper sheet, a film, or a cloth that is transported through a transfer medium transporting path L.

In addition, on the downstream of the transfer medium transporting path L, a first suction device 210, a transfer medium transporting device (transfer medium transporting unit) 230, and a second suction device (guide portion) 270 are sequentially disposed, and the transfer medium is configured to be transported to the fixing unit 90. The fixing unit 90 melts the monochrome toner image or the full-color toner image, which is transferred onto the transfer medium such as a paper sheet, so as to be fixed to the transfer medium such as a paper sheet.

The transfer belt 40 is stretched around the tension roller 42 together with the belt driving roller 41 and the like. The cleaning device that is formed by the transfer belt cleaning blade 49 is brought into contact with a place in which the transfer belt 40 is stretched around the tension roller 42 and performs a cleaning process for toner remaining on the transfer belt 40 and carriers.

The transfer medium is supplied to the image forming apparatus by a sheet feeding device (not shown). The transfer media that are set in the sheet feeding device are configured to be delivered to the transfer medium transporting path L one at each predetermined timing. In the transfer medium transporting path L, the transfer medium is transported to the secondary transfer position by gate rollers 101 and 101′ and a transfer medium guide 102. And a developed monochrome toner image or a developed full-color toner image that is formed on the transfer belt 40 is transferred to the transfer medium. The secondarily transferred transfer medium, as described above, is transported further to the fixing unit 90 by the transfer medium transporting unit that is mainly configured by the transfer medium transporting device 230. The fixing unit 90 is configured by a heating roller 91 and a pressing roller 92 that is biased to the heating roller 91 side at predetermined pressure. By inserting and passing the transfer medium through a nip, the monochrome toner image or the full-color toner image transferred onto the transfer medium is melted so as to be fixed to the transfer medium such as a paper sheet.

Here, the developing device will be described. The configuration of the image forming unit and the developing device is the same for each color. Thus, hereinafter, the image forming unit and the developing device of yellow (Y) will be described.

In the image forming unit, a photosensitive body cleaning blade 18Y, a corona charger 11Y, an exposure unit 12Y, a developing roller 20Y of the developing device 30Y, a first photosensitive body squeezing roller 13Y, and a second photosensitive body squeezing roller 13Y′ are disposed along the rotation direction of the outer circumference of the photosensitive body 10Y.

The photosensitive body cleaning blade 18Y that is brought into contact with the photosensitive body 10Y performs a cleaning process for the remaining liquid developer on the photosensitive body 10Y that has not been transferred.

On the outer circumference of the developing roller 20Y of the developing device 30Y, a cleaning blade 21Y, an anilox roller 32Y, and a compaction corona generator 22Y are disposed. A regulation blade 33Y that adjusts the amount of the liquid developer to be supplied to the developing roller 20Y is brought into contact with the anilox roller 32Y. Inside the liquid developer container 31Y, an auger 34Y is housed. In addition, in a position facing the photosensitive body 10Y, a primary transfer roller 51Y of the primary transfer unit is disposed with the transfer belt 40 interposed therebetween.

The photosensitive body 10Y is a photosensitive drum that is formed by a cylinder-shaped member having the outer circumferential face on which a photosensitive layer formed by an amorphous silicon photosensitive body or the like is formed. The photosensitive body 10Y rotates in the clockwise direction.

The corona charger 11Y is disposed on the upstream side in the rotation direction of the photosensitive body 10Y relative to the nip portion between the photosensitive body 10Y and the developing roller 20Y. The corona charger 11Y is applied with a voltage from a power supply device not shown in the figure and electrically charges the photosensitive body 10Y as corona charging. The exposure unit 12Y is disposed on the downstream side in the rotation direction of the photosensitive body 10Y relative to the corona charger 11Y. The exposure unit 12Y irradiates light onto the photosensitive body 10Y that is charged by the corona charger 11Y so as to form a latent image on the photosensitive body 10Y. From the start to the end of the image forming process, the configuration of rollers and the like that are disposed on the former stage is on the upstream side relative to the configuration of rollers and the like that are disposed on the latter stage.

The developing device 30Y includes the compaction corona generator 22Y that performs a compaction action and the developer container 31Y storing a liquid developer that is in the state in which toner of about wt 20% is dispersed into a carrier.

In addition, the developing device 30Y includes a developing roller 20Y that carries the liquid developer, an anilox roller 32Y that is a coating roller for coating the developing roller 20Y with the liquid developer, a regulation blade 33Y that regulates the amount of the liquid developer with which the developing roller 20Y is coated, an auger 34Y that supplies the liquid developer to the anilox roller 32Y while agitating and transporting the liquid developer, a compaction corona generator 22Y that allows the liquid developer carried in the developing roller 20Y in a compaction state, and a developing roller cleaning blade 21Y that performs cleaning for the developing roller 20Y.

The liquid developer housed in the developer container 31Y is not a volatile liquid developer having low density (about 1 to 3 wt %), low viscosity, and volatility at room temperature with Isopar (trademark of Exxon), which is generally used, used as a carrier but a non-volatile liquid developer having high density, high viscosity, and non-volatility at room temperature. In other words, the liquid developer in an embodiment of the invention is a liquid developer having high viscosity (it uses HAAKE RheoStress RS600 and has the viscoelasticity of about 30 to 300 mPa·s at the shear speed of 1000 (1/s) at 25° C.) that is acquired by adding solid particles having an average particle size of 1 μm, which are acquired by dispersing a coloring agent such as pigment into a thermoplastic resin, into a liquid solvent such as an organic solvent, silicon oil, mineral oil, or cooking oil together with dispersant so as to have a toner solid content density of about 15 to 25%.

The anilox roller 32Y serves as a coating roller that coats the developing roller 20Y by supplying the liquid developer thereto. The anilox roller 32Y is a cylindrical member. The anilox roller 32Y is a roller having the face on which an uneven surface is formed by grooves that are delicately and uniformly carved in a spiral shape for easily carrying the developer by the surface thereof. The liquid developer is supplied from the developer container 31Y to the developing roller 20Y by the anilox roller 32Y. When the apparatus is operated, as shown in FIG. 1, the auger 34Y rotates in the counterclockwise direction, thereby supplying the liquid developer to the anilox roller 32Y. Then, the anilox roller 32Y rotates in the counterclockwise direction, thereby coating the developing roller 20Y with the liquid developer.

The regulation blade 33Y is a metal blade having a thickness of about 200 μm and is installed on the surface of the anilox roller 32Y. The regulation blade 33Y regulates the film thickness and the amount of the liquid developer that has been carried and transported by the anilox roller 32Y, thereby adjusting the amount of the liquid developer to be supplied to the developing roller 20Y.

The developing roller cleaning blade 21Y is configured by rubber or the like that is brought into contact with the surface of the developing roller 20Y. The developing roller cleaning blade 21Y is disposed on the downstream side of the developing nip portion, in which the developing roller 20Y is brought into contact with the photosensitive body 10Y, in the rotation direction of the developing roller 20Y and eliminates the liquid developer remaining in the developing roller 20Y by scraping it off.

The compaction corona generator 22Y is a voltage applying unit that increases the charging bias of the surface of the developing roller 20Y. An electric field is applied toward the developing roller 20Y from the compaction corona generator 22Y side in the compaction portion by the compaction corona generator 22Y. This corona presses for compaction the solid content to the developing roller side so as to allow particles to be formed as films to be divided into a carrier layer and a solid content layer by applying an electric field to the liquid developer film on the surface of the developing roller, whereby the developing speed and the developing efficiency are improved. In addition, as the electric field applying unit for the above-described compaction, a compaction roller or the like can be used instead of corona discharging of the corona discharger shown in FIG. 1.

The developer that is carried in the developing roller 20Y and compacted is developed in response to a latent image of the photosensitive body 10Y in the developing nip portion in which the developing roller 20Y is brought into contact with the photosensitive body 10Y by applying a predetermined electric field.

The developer remaining after developing is eliminated by being scraped off by the developing roller cleaning blade 21Y and falls in drops into a collection portion inside the developer container 31Y for reuse. The carrier and the toner that are reused as described above are not in a color-mixed state.

The photosensitive body squeezing device that is disposed on the upstream side of the primary transfer is disposed to face the photosensitive body 10Y on the downstream side of the developing roller 20Y, and thereby collecting redundant carrier of the toner image developed in the photosensitive body 10Y. This photosensitive body squeezing device is configured by a first photosensitive body squeezing roller 13Y and a second photosensitive body squeezing roller 13Y′ formed by elastic roller members that are rotated in the state of sliding contact with the photosensitive body 10Y. The photosensitive body squeezing device has a function of increasing the toner particle ratio inside the developed image (toner image) by collecting the redundant carrier and unnecessary fog toner from the toner image developed on the photosensitive body 10Y. In addition, a predetermined bias voltage is applied to the photosensitive body squeezing rollers 13Y and 13Y′.

The surface of the photosensitive body 10Y passing through the squeezing device, which is formed by the first photosensitive body squeezing roller 13Y and the second sensitive body squeezing roller 13Y′ described above, enters into the primary transfer unit 50Y.

In the primary transfer unit 50Y, a developer image developed in the photosensitive body 10Y is transferred to the transfer belt 40 by the primary transfer roller 51Y. In this primary transfer unit 50Y, the toner image formed on the photosensitive body 10 is transferred to the transfer belt 40 side by the action of a transfer bias applied to a primary transfer backup roller 51. Here, the photosensitive body 10Y and the transfer belt 40 are configured to be moved at a constant speed and suppress a disturbance action applied to the developed toner image of the photosensitive body 10Y together with decreasing the driving load for rotation and movement.

By performing the same process as the developing process of the above-described developing device 30Y, toner images of magenta (M), cyan (C), and black (K) are formed on the photosensitive bodies 10M, 10C, and 10K in the developing devices 30M, 30C, and 30K. Then, the transfer belt 40 passes through the nips of the primary transfer units 50 of the colors of yellow (Y), magenta (M), cyan (C), and black (K), the developers (developed images) on the photosensitive bodies of the colors are transferred, the colors are superimposed, and enters into the nip portion of the secondary transfer unit 60.

The transfer belt 40 that has gone through the secondary transfer unit 60 revolves so as to receive transfer images from the primary transfer units 50 again. A cleaning process is performed for the transfer belt 40 by the transfer belt cleaning blade 49 or the like on the upstream side of the positions at which the primary transfer units 50 are operated.

The transfer belt 40 has a three-layer structure in which an elastic intermediate layer formed of polyurethane is disposed on a polyimide base layer, and a PFA surface layer is disposed thereon. Such a transfer belt 40 is stretched over the driving roller 41 and the tension rollers 42, 52, and 53 on the polyimide base layer side and is used such that a toner image is transferred on the PFA surface layer side. The transfer belt 40 having elasticity, which is formed as described above, has an excellent characteristic of following and responding to the surface of the transfer medium. Accordingly, the transfer belt 40 can be effectively used to feed and transfer toner particles, particularly with a small particle size, to concave portions of the transfer medium in the secondary transfer.

In the lower portion of the second suction device 270, a transfer medium detecting sensor 133 that detects the existence of a transfer medium S passing through the second suction device 270 is disposed. As this transfer medium detecting sensor 133, a reflection-type in which the existence of a transfer medium S is detected by detecting reflection from the transfer medium S by using an optical sensor, which is configured by a combination of a light emitting device and a light sensing device, is used. However, a transmission-type can be used as the transfer medium detecting sensor 133.

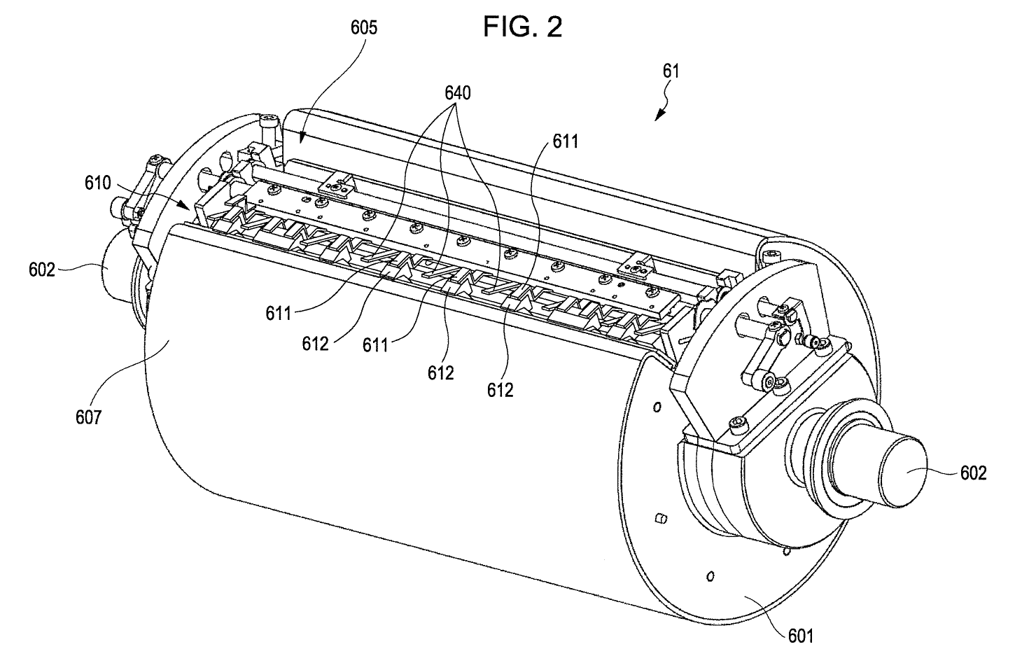

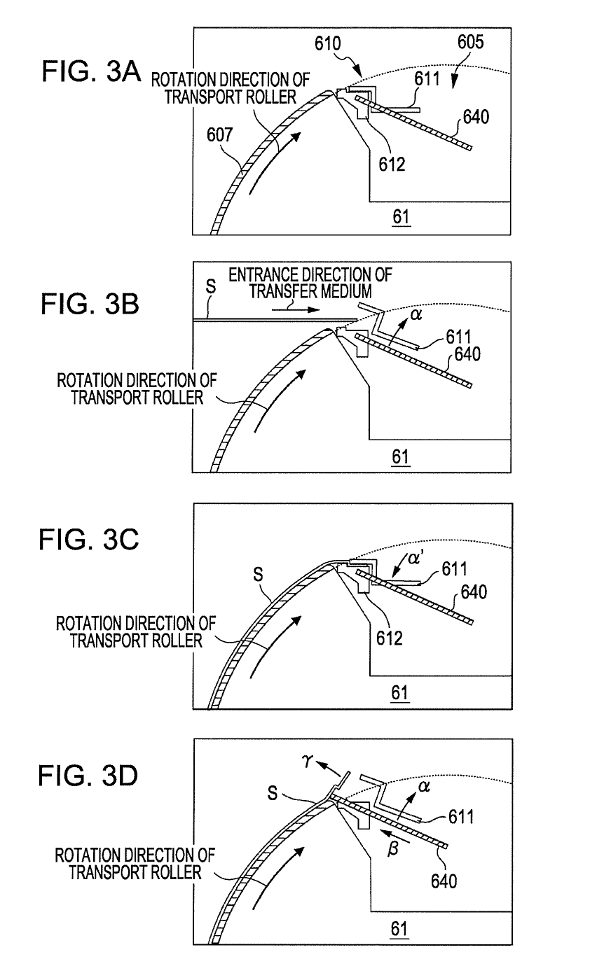

Next, the secondary transfer roller 61 that is used in an image forming apparatus according to this embodiment will be described in detail. FIG. 2 is a perspective view of the secondary transfer roller that is used in an image forming apparatus according to an embodiment of the invention. FIGS. 3A to 3D are diagrams illustrating the operation of a transfer medium gripping mechanism of a secondary transfer roller used in an image forming apparatus according to an embodiment of the invention. In FIGS. 2 and 3A to 3D, 601 denotes a roller driving portion, 602 denotes a roller shaft portion, 605 denotes an opening concave portion, 607 denotes an elastic member, 610 denotes a transfer medium gripping mechanism, 611 denotes a transfer medium gripping portion, 612 denotes a transfer medium gripping portion receiving portion, and 640 denotes a transfer medium detaching portion.

In both end portions of a roller body portion 601 of the secondary transfer roller 61, the roller shaft portion 602 is disposed. The secondary transfer roller 61 is configured to be disposed to the apparatus main body side so as to be rotatable around the roller shaft portion 602. In addition, the opening concave portion 605 that stretches in the shaft direction is disposed in the roller body portion 601, and the transfer medium gripping mechanism 610 is disposed inside the opening concave portion 605. In addition, the elastic member 607 is disposed in the roller body portion 601 other than the opening concave portion 605. The transfer medium gripping mechanism 610 is a mechanism that is used for gripping or releasing a transfer medium. The elastic member 607 is configured as a semi-conductive elastic rubber layer having an electric resistance component. When a transfer medium passes through the secondary transfer nip of the secondary transfer unit in the state being wound around the elastic member 607, a toner image is transferred from the transfer belt 40 to the transfer medium.

The transfer medium gripping mechanism 610 is mainly configured by combinations of the transfer medium gripping portions 611 and the transfer medium gripping portion receiving portions 612, which are discretely disposed in the direction of the roller shaft, and a plurality of the transfer medium detaching members 640 that are appropriately disposed between the combinations of the transfer medium gripping portions 611 and the transfer medium gripping portion receiving portions 612 along the roller shaft direction. All the transfer medium gripping portions 611 are configured to be movable. Thus, the transfer medium gripping portion 611 can grip a transfer medium by operating so as to pinch the transfer medium between the transfer medium gripping portion receiving portion 612 and the transfer medium gripping portion 611 or can release the transfer medium by operating to open the gap between the transfer medium gripping portion receiving portion 612 and the transfer medium gripping portion 611. In addition, all of the transfer medium detaching members 640 operate so as to push the transfer medium gripped by the transfer medium gripping portion 611 and the transfer medium gripping portion receiving portion 612 in the direction away from the secondary transfer roller 61 side.

The operation of the transfer medium gripping mechanism 610 will be described in detail with reference to FIGS. 3A to 3D. FIGS. 3A to 3D are schematic diagrams showing the configurations of the transfer medium gripping mechanism 610 viewed from the shaft direction. In addition, the states of the transfer medium gripping mechanism 610 shown in FIGS. 3A, 3B, 3C, and 3D schematically illustrate the operation states of the transfer medium gripping mechanism 610 when the transfer medium gripping mechanism 610 of the secondary transfer roller 61 arrives at positions marked as I, II, III, and IV of the secondary transfer roller 61 shown in FIG. 1.

FIG. 3A illustrates a state in which the secondary transfer roller 61 rotates without gripping the transfer medium by using the transfer medium gripping mechanism 610. At this time, when the secondary transfer roller 61 is assumed to be viewed as a circular cylinder, the transfer medium gripping portion 611 and the transfer medium detaching member 640 are inside the outermost circular cylinder. This represents a state in which the transfer medium gripping mechanism 610 is placed in the range of I shown in FIG. 1 during the rotation process of the secondary transfer roller 61.

FIG. 3B illustrates a state in which the transfer medium gripping portion 611 is moved in the α direction so as to form a predetermined space between the transfer medium gripping portion receiving portion 612 and the transfer medium gripping portion 611. And preparation for pinching the transfer medium S entering into the space by using the transfer medium gripping portion 611 and the transfer medium gripping portion receiving portion 612 is performed. This represents a state in which the transfer medium gripping mechanism 610 is moved to the II position shown in FIG. 1 and performs preparation for gripping a transfer medium that approaches along the transfer medium guide 102 together with the rotation of the gate rollers 101 and 101′ during the rotation process of the secondary transfer roller 61.

FIG. 3C illustrates a state in which the transfer medium gripping portion 611 is moved in the α′ direction and the transfer medium S that has entered into the space is pinched between the transfer medium gripping portion receiving portion 612 and the transfer medium gripping portion 611. At this time, the transfer medium S having one end gripped by the transfer medium gripping mechanism 610 is wound around the roller body portion 601 of the secondary transfer roller 61 in accordance with the rotation of the secondary transfer roller 61. As described above, in a stage prior to entering of the transfer medium into the secondary transfer nip, the transfer medium S is gripped so as to be fixed by the transfer medium gripping mechanism 610. Accordingly, the position of the transfer medium S in which a toner image is transferred can be determined with high precision. During the rotation process of the secondary transfer roller 61, when the transfer medium gripping mechanism 610 is positioned in the range of III shown in FIG. 1, the state shown in FIG. 3C is maintained.

FIG. 3D illustrates a state in which the transfer medium gripping portion 611 is moved in the α direction and forms a predetermined space between the transfer medium gripping portion receiving portion 612 and the transfer medium gripping portion 611 so as to release the transfer medium S. And the transfer medium detaching member 640 is moved in the β direction so as to press the transfer medium S in a direction far away from the secondary transfer roller 61. Such an operation state is formed when the transfer medium gripping mechanism 610 is moved to the position IV shown in FIG. 1, and the transfer medium S onto which the toner image is transferred through the secondary transfer nip is delivered to the next transfer medium transporting process, during the rotation process of the secondary transfer roller 61.

As described above, the transfer medium gripping mechanism 610 grips the transfer medium S before the transfer medium S passes through the secondary transfer nip between the transfer belt 40 and the secondary transfer roll 61. And releases the gripped transfer medium S after the transfer medium S passes through the secondary transfer nip between the transfer belt 40 and the secondary transfer roller 61. The transfer medium S passing through the secondary transfer nip reliably separates the transfer medium S from the secondary transfer roller 61 by operating the transfer medium gripping mechanism 610 as shown in FIG. 3D and can reliably lead the transfer medium to the next transfer medium transporting process. Generally, in an image forming process using a liquid developer, the transfer medium S onto which the toner image is transferred in the secondary transfer nip may be attached to any one of the secondary transfer roller 61 and the transfer belt 40, so that it may be difficult to peel the transfer medium apart. However, by performing the operation of the transfer medium gripping mechanism 610 shown in FIG. 3D, the transfer medium S can be reliably peeled apart from each constituent member.

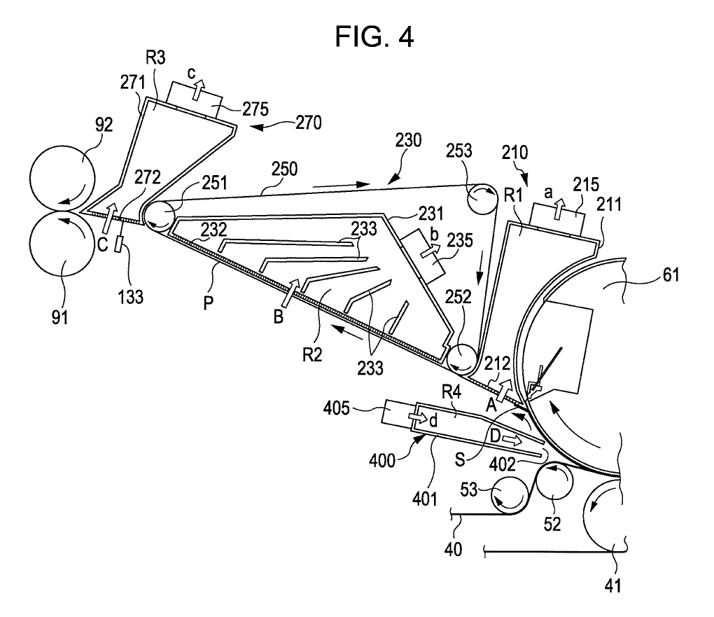

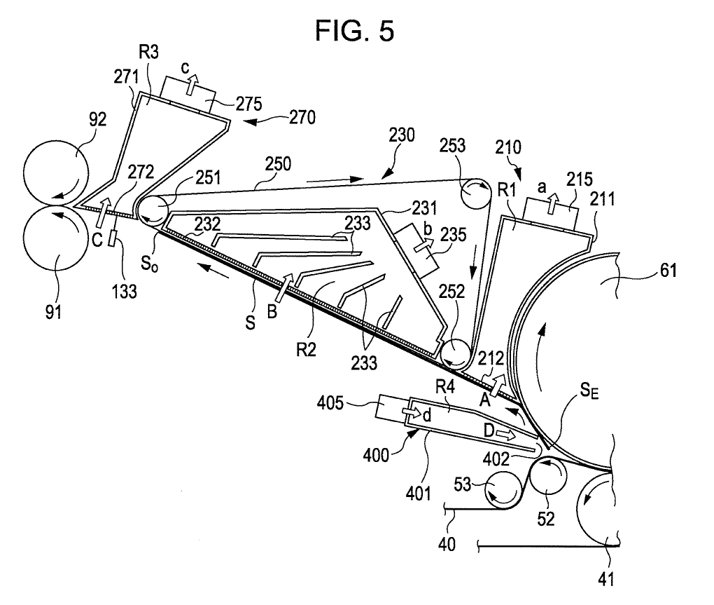

The transfer medium S that is released from the transfer medium gripping mechanism 610 as described above is transported up to the next transfer unit 60. A transport unit that performs the transport operation will be described later. FIGS. 4 and 5 are diagrams illustrating the operation of a transfer medium transporting unit used in an image forming apparatus according an embodiment of the invention. In FIGS. 4 and 5, 210 denotes a first suction device, 211 denotes a casing portion, 212 denotes a suction surface, 215 denotes an airflow generating unit, 230 denotes a transfer medium transporting device, 231 denotes a casing portion, 232 denotes a suction surface, 233 denotes a partition wall member, 235 denotes an airflow generating unit, and 250 denotes a transfer medium transporting member. In addition, 251 denotes a transfer medium transporting member driving roller, 252 and 253 denote transfer medium transporting member stretching rollers, 270 denotes a secondary suction device, 271 denotes a casing portion, 272 denotes a suction surface, 275 denotes an airflow generating unit, 400 denotes a blower device, 401 denotes a casing portion, 402 denotes an opening portion, and 405 denotes an airflow generating unit.

The first suction device 210 includes the casing portion 211 to which the airflow generating unit 215 such as a sirocco fan is attached. Thus, the air can be discharged from a space R1 inside the casing portion 211 to the outside of the casing portion 211 by the airflow generating unit 215. The lower face side of the casing portion 211 is a suction surface 212 acquired by forming a plurality of air holes in one surface. The first suction device 210 generates a suction force as denoted by A by exhausting as denoted by a to the outside of the casing portion 211 by operating the airflow generating unit 215. Depending on this suction force, the transfer medium S onto which the toner image is transferred is maintained on the suction surface 212 in resistance to the gravitational force. The level of the suction force can allow the transfer medium S to be maintained on the suction surface 212 but does not disturb the advance of the transfer medium S in resistance to the force of pushing the transfer medium S from the secondary transfer nip.

The transfer medium transporting device 230 is mainly configured by the casing portion 231 to which the airflow generating unit 235 such as a sirocco fan is attached, the transfer medium transporting member 250 that is disposed on the periphery of the casing portion 231, and the like. In the transfer medium transporting device 230, the air can be discharged from a space R2 inside the casing portion 231 to the outside of the casing portion 231 by using the airflow generating unit 235.

The lower face side of the casing portion 231 is the suction surface 232 that includes a plurality of air holes in one surface. In accordance with the exhaust operation b of the airflow generating unit 235, a suction force as denoted by B is generated on the suction surface 232. At this time, by the action of the partition wall member 233 that is also applied to the inside of the casing portion 231, the air is relatively uniformly discharged from the space R2 inside the casing portion 231. Accordingly, there is no bias in the suction force on the suction surface 232 depending on the position.

The transfer medium transporting member 250 that is disposed on the periphery of the casing portion 231 is a ring-shaped belt in which a plurality of air holes (not shown) perforating the ring-shaped belt is disposed. The transfer medium transporting member 250 is stretched over the transfer medium transporting member driving roller 251 that applies a driving force to the transfer medium transporting member 250 and the transfer medium transporting member stretching rollers 252 and 253. The transfer medium transporting member 250 is moved in the direction of an arrow shown in the figure by rotating the transfer medium transporting member driving roller 251, and the movement speed is approximately the same as that of the image forming process. The length (the width of the transfer medium transporting member 250) of the transfer medium transporting member 250 is configured to be longer than the width of a transfer medium having the maximum width that can be processed by the image forming apparatus.

The suction force at the suction surface 232 of the casing portion 231 is also applied from the air holes of the transfer medium transporting member 250. Accordingly, the transfer medium S onto which the toner image is transferred is maintained on the transport surface P of the transfer medium transporting member 250 in resistance to the gravitational force and is transported on the transport surface P in accordance with the movement of the transfer medium transporting member 250 depending on the driving force of the transfer medium transporting member driving roller 251. An area from the transfer medium transporting member stretching roller 252 of the transfer medium transporting member 250 to the transfer medium transporting member driving roller 251 is used as the transport surface P that transports the transfer medium S.

The second suction device 270 includes the casing portion 271 to which the airflow generating unit 275 such as a sirocco fan is attached. Thus, the air can be discharged from a space R3 inside the casing portion 271 to the outside of the casing portion 271 by the airflow generating unit 275. The lower face side of the casing portion 271 is a suction surface 272 acquired by forming a plurality of air holes in one surface. Accordingly, by the exhaust operation c of the airflow generating unit 275 of the second suction device 270, a suction force as denoted by C can be generated. Depending on this suction force, the transfer medium S onto which the toner image is transferred is maintained on the suction surface 272 in resistance to the gravitational force. The level of the suction force can allow the transfer medium S to be maintained on the suction surface 272 but is not high enough to disturb the transport of the transfer medium S in resistance to the force of transporting the transfer medium S.

Here, the “airflow” in this embodiment is defined as the flow amount of the air per unit time when the opening area of the air holes of a member (for example, the transfer medium transporting member) that is brought into contact with the transfer medium S is constant.

The transfer medium transporting unit according to this embodiment that is configured by the first suction device 210, the transfer medium transporting device 230, the second suction device 270, and the like transports the transfer medium with the surface of the transfer medium, onto which the toner image is transferred, is disposed on the lower side in the vertical direction.

The blower device 400 is used for discharging the air to a space between the transfer belt 40 and the secondary transfer roller 61 that is located near the outlet of the secondary transfer nip. The air is fed to a space R4 inside the casing portion 401 by the airflow generating unit 405 such as a sirocco fan. In this casing portion 401, an opening portion 402 that extends along the shaft direction of the rollers is disposed. Accordingly, the air fed inside the casing portion 401 in accordance with the airflow generating operation d of the airflow generating unit 405 is discharged from the opening portion 402 as denoted by D. The discharging force of the air at this time is adjusted such that the transfer medium S, onto which the toner image is transferred, is not hung down in resistance to the gravitational force and the transfer medium S does not flutter due to the air.

Next, the operation of the transfer medium transporting unit according to this embodiment that is configured as described above will be described. FIG. 4 shows a state right after the front end portion (S₀) of the transfer medium S in the transport direction is discharged from the secondary transfer nip of the secondary transfer unit 60, that is, a state right after the transfer medium S is delivered from the secondary transfer unit 60 side to the transport unit side. The transfer medium S, as shown in the figure, is slid to be transported on the suction surface 212 depending on the force of the feed operation on the secondary transfer unit 60 side while being maintained on the suction surface 212 by the suction force A of the suction surface 212 that is generated in accordance with the operation a of the airflow generating unit 215 without falling off. In addition, since the surface of the transfer medium S that is attached by the suction surface 212 is a surface onto which any toner image has not been formed by the prior secondary transfer operation, an unfixed toner image is not disturbed by the transport operation of the transport unit. In addition, according to this embodiment, by disposing the first suction device 210, the discharge orientation of the transfer medium S can be stably maintained. As a result, it can be prevented that the unfixed toner image is disturbed by bringing the toner image forming surface of the transfer medium S into contract with a member such as the transfer belt 40 that is located on the lower side in the direction of gravity. In addition, by interposing the first suction device 210, which sucks the transfer medium S, between the secondary transfer roller 61 and the transfer medium transporting device 230, the orientation of the transfer medium can follow air suction after the front end of the transfer medium is separated from the belt and the transfer roller 61. Accordingly, the orientation of the transfer medium can be stabilized.

When the front end portion of the transfer medium S, which is slid to be transported on the suction surface 212 of the first suction device 210, arrives at the transfer medium transporting device 230 side by receiving the force of the feed operation from the secondary transfer unit 60 side. Next, the transfer medium S is transported toward the fixing unit 90 on the transport surface P in accordance with the movement operation of the transfer medium transporting member 250 while being maintained by the suction force B at the transport surface P of the transfer medium transporting member 250.

FIG. 5 illustrates a state right after the rear end portion (S_{E}) of the transfer medium S in the transport direction is discharged from the secondary transfer nip of the secondary transfer unit 60. In particular, at this time, by discharging the air as denoted by D by operating the blower device 400, an image can be prevented from being defaced by bringing the rear end portion (S_{E}) of the transfer medium into contact with the transfer belt 40 or the like when the rear end portion (S_{E}) of the transfer medium S is discharged from the secondary transfer nip.

According to this embodiment, the blower device 400 that discharges the air into the nip outlet space between the secondary transfer roller 61 and the transfer belt 40 as described above is disposed. Thus, the transfer medium can be pressed to the secondary transfer roller 61 side even after the rear end (S_{E}) of the transfer medium is discharged from the secondary transfer nip. Accordingly, the orientation of the transfer medium S after being discharged from the secondary transfer nip can be stabilized.

In other words, in the image forming apparatus according to an embodiment of the invention, the blower device 400 that is interposed between the transfer belt 40 and the secondary transfer roller 61 and discharges an airflow toward the surface of the transfer medium S, onto which the image is transferred, released by the transfer medium gripping mechanism 610 is included. Since the orientation of the transfer medium S is controlled by applying the airflow discharged from the blower device 400 to the transfer medium S, there is no possibility of defacing the surface (print surface) onto which an image is transferred. In addition, deterioration of the image quality due to the defacement of the image can be suppressed.

The transfer medium S shown in FIG. 5 is a transfer medium having the maximum length in the transport direction, which can be processed by the apparatus. In the image forming apparatus according to an embodiment of the invention, even when a transfer medium having the maximum length is used, dimensions of each constituent members are determined so as to be in the state in which the transfer medium S is not stuck in any of the fixing nips of the fixing unit 90 and the secondary transfer nip of the secondary transfer unit 60. Accordingly, even when there is a difference in the transport speed of the transfer medium S between the fixing unit 90 and the secondary transfer unit 60, the transfer medium S is not loosened or pulled. Therefore, it is possible to avoid a negative effect on the image or the like.

In addition, even if there is a difference between the transport speed of the secondary transfer unit 60 and the transport speed of the transfer medium transporting member 250 when the transfer medium S is transported on the transport surface P of the transfer medium transporting device 230 in the state of being pinched in the secondary transfer nip of the secondary transfer unit 60, the transfer medium S that is held by the transfer medium transporting member 250 is held in accordance with the suction force through the air. Accordingly, the transfer medium S can be slid on the transfer medium transporting member 250, whereby loosening or pulling of the transfer medium S or the like does not occur.

Similarly, if there is a difference between the transport speed of the fixing unit 90 and the transport speed of the transfer medium transporting member 250 when the transfer medium S is transported on the transport surface P of the transfer medium transporting device 230 in the state of being pinched in the fixing nip of the fixing unit 90, the transfer medium S can be slid on the transfer medium transporting member 250. Accordingly, loosening or pulling of the transfer medium S or the like does not occur.

As presented in the above description, the transfer medium transporting device 230 can serve as a mechanism for absorbing a difference between the transport speeds of the transfer medium S in the units.

The transfer medium S that is transported by the transport surface P of the transfer medium transporting device 230 passing through the suction surface 272 of the second suction device 270 enters into the fixing nip formed by the heating roller 91 of the fixing unit 90 and the pressing roller 92. On the transfer medium S that has passes through the fixing nip, the toner image is melted so as to form a permanent visible image.

In an image forming method using a liquid developer, high fixing efficiency of the fixing unit 90 can be attained when a predetermined time elapses after the secondary transfer at the secondary transfer unit 60. The reason for this is that carriers that inhibit the fixing penetrate into the transfer medium if a predetermined time elapses. If a layout in which the fixing unit 90 is disposed right after the secondary transfer unit 60 is used, the transfer medium S receives the transfer of toner from the secondary transfer unit 60, and the toner is fixed without an interval. Accordingly, there is concern about lowering the fixing efficiency. However, according to an image forming apparatus of an embodiment of the invention, a layout in which the transport unit that is configured by the first suction device 210, the transfer medium transporting device 230, the second suction device 270, and the like is disposed between the secondary transfer unit 60 and the fixing unit 90 is used. Accordingly, a predetermined time can be secured until a fixing process is performed after the secondary transfer in accordance with the time required for the transport of the transfer medium S. Therefore, high fixing efficiency of the fixing unit 90 can be attained.

In addition, according to an image forming apparatus of an embodiment of the invention, the first suction device 210 that sucks the transfer medium S discharged from the secondary transfer unit 60 is disposed. Accordingly, the transfer medium S after the secondary transfer can be discharged to a space formed above the transfer belt 40, and the fixing unit 90 can be disposed by utilizing the space. Therefore, there is an advantage in that the installation area of the apparatus can be decreased.

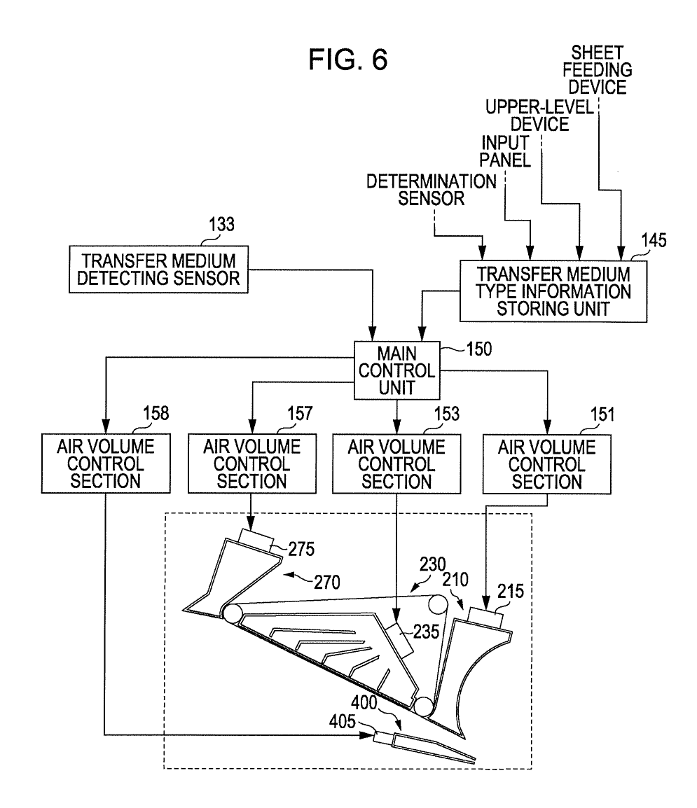

Next, control of the image forming apparatus according to an embodiment of the invention that is configured as described above will be described. FIG. 6 is a schematic diagram showing control blocks of an image forming apparatus according to an embodiment of the invention. In FIG. 6, 145 denotes a transfer medium type information storing unit, 133 denotes a transfer medium detecting sensor, 150 denotes a main control unit, and 151, 153, 157, and 158 denote air volume control sections.

The main control unit 150 is a main controller that performs control processes of the image forming apparatus according to an embodiment of the invention. Such a main control unit 150 can be implemented by storing a program that allows a CPU to perform an operation of outputting a command to a predetermined block based on input predetermined information in a ROM in advance by using a general-purpose information processing apparatus that includes the CPU, a RAM, the ROM, and the like.

The transfer medium detecting sensor 133 is a constituent member that detects the state of passing of the transfer medium S in the lower portion of the second suction device 270. By using the transfer medium detecting sensor 133, the main control unit 150 can confirm the transport state of the transport medium S.

The transfer medium type information storing unit 145 is a storage unit that temporarily stores data relating to the type of the transfer medium on which an image is formed by the image forming apparatus. The transfer medium type information storing unit 145 is configured to acquire, for example, information transmitted from a determination sensor (not shown) that determines the type of the transfer medium loaded inside the image forming apparatus, information that is manually input by a user through an input panel (not shown) or the like that is disposed in the casing of the image forming apparatus, information transmitted from a higher-level apparatus that outputs an execution command for image formation to the image forming apparatus, or information transmitted from a sheet feeding device that supplies the transfer medium to the image forming apparatus and store the information therein. The transfer medium type data that is stored in the transfer medium type information storing unit 145 is appropriately used for the control process of the main control unit 150.

The air volume control sections 151, 153, 157, and 158 control the air volumes when airflows are generated by the airflow generating unit 215 of the first suction device 210, the airflow generating unit 235 of the transfer medium transporting device 230, the airflow generating unit 275 of the second suction device 270, and the airflow generating unit 405 of the blower device 400. Described in more detail, the air volume control section is a controller that controls the speed of a motor installed on the fan forming each airflow generating unit. The main control unit 150 outputs control commands to the air volume control sections 151, 153, 157, and 158, thereby controlling the air volumes generated by the airflow generating units. Accordingly, the suction force for the transfer medium or the amount of discharged air for the transfer medium can be freely controlled. In addition, in this embodiment, the description is made based on an example in which the air volume is controlled by controlling the motor of the fan. However, it may be configured that a duct that can be opened or closed is disposed inside each casing portion, and the air volume is controlled by opening or closing the duct.

The image forming apparatus according to an embodiment of the invention includes the transfer medium type information storing unit 145, and the main control unit 150 controls the transport unit that is configured by the first suction device 210, the transfer medium transporting device 230, the second suction device 270, and the like and the blower device 400 based on the information relating to the transfer medium type. Accordingly, the transport conditions of the transfer medium and the like can be easily changed in response to the type of the transfer medium.

In addition, in the image forming apparatus according to an embodiment of the invention, the air volume control sections 151, 153, and 157 serve as air volume control units that adjust the air volumes at the time of suction of the transfer medium. Thus, the suction force at the time of suction of the transfer medium by using the transport unit such as the first suction device 210, the transfer medium transporting device 230, and the second suction device 270 can be adjusted, for example, in response to the type of the transfer medium. Therefore, the responsiveness of the apparatus to the transfer medium type is improved.

Described in more detail, for example, if a thin sheet is sucked with a suction force that is the same as one used for a thick sheet, the stiffness of the thin sheet is weaker than that of the thick sheet. Accordingly, the stiffness of the thin sheet is outdone by the suction force. Thus, there is a case where the sheet is not transported by the suction surface 212 and the suction surface 272 but stopped so as to be wrinkled. However, by setting the suction force for the thin sheet, for example, to a half of that for the thick sheet, the thin sheet can be sufficiently transported with the stiffness of the thin sheet. Accordingly, wrinkling of the thin sheet can be prevented.

In addition, in the image forming apparatus according to an embodiment of the invention, the air volume control section 158 serves as an air volume adjusting unit that adjusts the air volume at the time of sending the air by using the blower device 400. Accordingly, for example, the air volume discharged from the blower device 400 can be adjusted in response to the type of the transfer medium, and thus, the responsiveness of the apparatus for the type of the transfer medium is improved.

Described in more detail, if a thin sheet is pressed with the same air volume as for a thick sheet in the outlet space of the secondary transfer nip between the transfer belt 40 and the transfer roller 61, the thin sheet flutters due to the discharged air. Thus, the image surface is brought into contact with a member located inside the apparatus due to the fluttering. As a result, there is a case where the image is disturbed or the sheet is wrinkled. However, for example, by setting the discharged air volume to a half of that for the thick sheet, the thin sheet can be pressed to the above-described space side without fluttering.

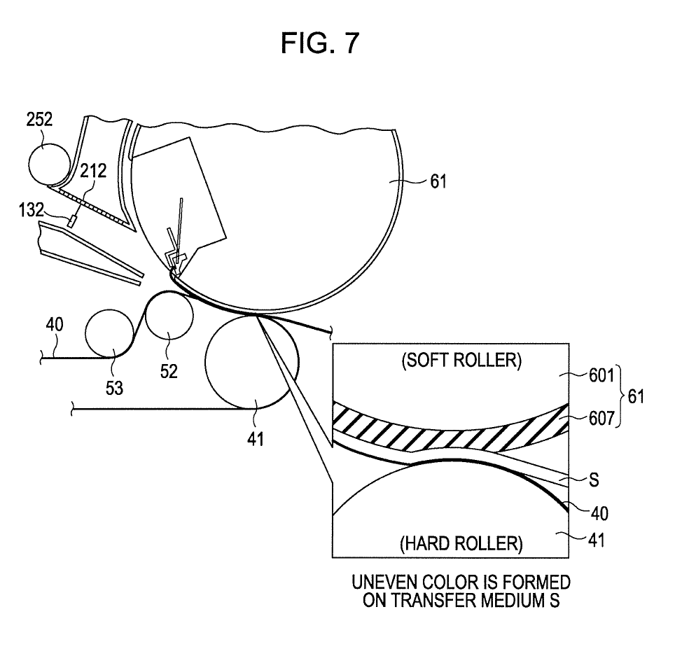

Next, curling of the transfer medium S will be described if the transfer medium S passes through the secondary transfer nip of the secondary transfer unit 60. FIG. 7 is a schematic diagram showing a transfer medium S that passes through the secondary transfer nip.

Since the belt driving roller 41 of two rollers of the secondary transfer unit 60 has the purpose of being rotated for driving the transfer belt 40 with high precision, a hard roller is used. Described in more detail, the belt driving roller 41 that is made by coating a steel roller surface with a urethane layer, which is used for increasing the abrasion with the surface of the steel roller, having a thickness of about 10 μm is used.

In addition, as the secondary transfer roller 61 that is the other roller of the two rollers configuring the secondary transfer unit 60, a soft roller that is softer than the above-described hard roller is used. The softness of the secondary transfer roller 61 is due to the elastic member 607. As the elastic member 607, a multi-layered rubber sheet that is made by superimposing conductive urethane rubber having JIS A 50 degrees and a thickness of 2 mm on conductive polyamide-imide having a thickness of 100 μm is used. In addition, although there is a coat of 15 μm coated with fluorine-series rubber on the surface of the conductive urethane rubber, the hardness of the urethane rubber layer that mainly forms the thickness determines the surface-layer hardness of the secondary transfer roller 61.

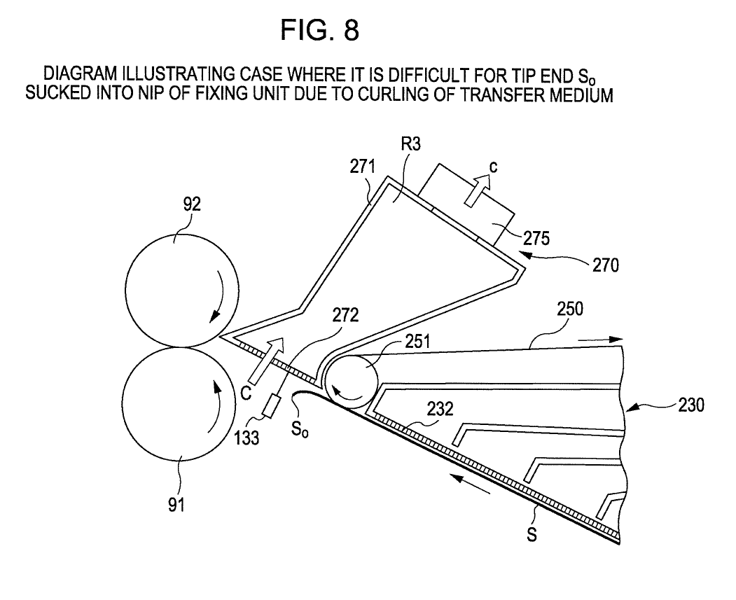

Since the secondary transfer unit 60 is configured as described above, in this embodiment, the secondary transfer roller 61 side through which the transfer medium S passes is formed in a concave pattern, and curling protruding to the upper side is formed in the transfer medium S. When such curling is formed, as shown in FIG. 8, the front end portion (S₀) of the transfer medium S in the transport direction faces downward in the vertical direction. Accordingly, when the transfer medium S is delivered to the fixing unit 90 from the transfer medium transporting device 230 and the second suction device 270, it is difficult for the transfer medium S to be appropriately sucked at a predetermined position of the fixing unit 90. Such tendency differs depending on the thickness of the transfer medium S. Thus, this embodiment is configured such that transport can be appropriately performed in response to the thickness of the transfer medium S by controlling the airflow generating unit 275 of the second suction device 270 based on a difference in the thickness.

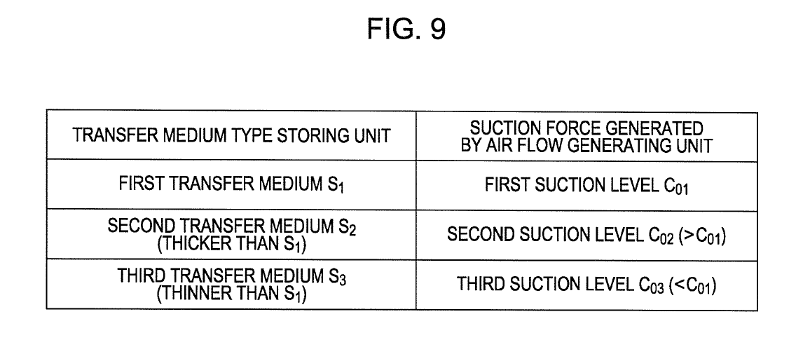

FIG. 9 is a diagram showing a control table of the airflow generating unit 275 according to the type of the transfer medium S. In this embodiment, the airflow generating unit 275 is controlled as below in response to the type of the transfer medium that is stored in the transfer medium type information storing unit 145.

First, when the type of the transfer medium that is stored in the transfer medium type information storing unit 145 is the first transfer medium S₁, the main control unit 150 and the air volume control section 157 control the airflow generating unit 275 to suck the first transfer medium S₁ with the first suction force C₀₁.

When the second transfer medium S₂ that is thicker than the first transfer medium S₁ is used, curling with a stronger stiffness is formed. Accordingly, the suction force of the second suction device 270 is controlled to be higher than the first suction force C₀₁. Described in more detail, when the type of the transfer medium stored in the transfer medium type information storing unit 145 is the second transfer medium S₂ that is thicker than the first transfer medium S₁, the main control unit 150 and the air volume control section 157 control the airflow generating unit 275 to suck the transfer medium with the second suction force C₀₂ that is stronger than the first suction force C₀₁.

On the other hand, when the third transfer medium S₃ that is thinner than the first transfer medium S₁ is used, curling with a weaker stiffness is formed. Accordingly, the suction force of the second suction device 270 is controlled to be lower than the first suction force C₀₁. Described in more detail, when the type of the transfer medium stored in the transfer medium type information storing unit 145 is the third transfer medium S₃ that is thinner than the first transfer medium S₁, the main control unit 150 and the air volume control section 157 control the airflow generating unit 275 to suck the transfer medium with the third suction force C₀₃ that is weaker than the first suction force C₀₁.

According to this embodiment, by performing the above-described control process, uplift of the transfer medium due to curling of the transfer medium can be prevented when the transfer medium is transported. Accordingly, jamming does not occur due to the transfer medium dropping out from the transport medium transporting member 250, and deterioration of the image quality caused by defective fixing does not occur due to misleading of the transfer medium to a predetermined position of the fixing unit.

Next, a more desirable control example for the transport of the transfer medium S in the fixing unit 90 will be described. In this embodiment, when the front end portion (S₀) of the transfer medium S in the transport direction arrives at the nip formed by the heating roller 91 of the fixing unit 90 and the pressing roller 92, the suction force with which the airflow generating unit 275 of the second suction device 270 sucks the transfer medium is controlled to be decreased. The reason for this is to allow the fixing unit to be influenced as less as possible by the transport of the transport medium S in the second suction device 270.

In order to control to decrease the suction force, the suction force of the second suction device 270 is controlled in a way as shown in the table in FIG. 9. When the suction force is lowered too much, the transfer medium may drop out from the transfer medium transporting device 230 depending on the thickness of the transfer medium S. Thus, the reason for such control of the suction force is to prevent such a situation.

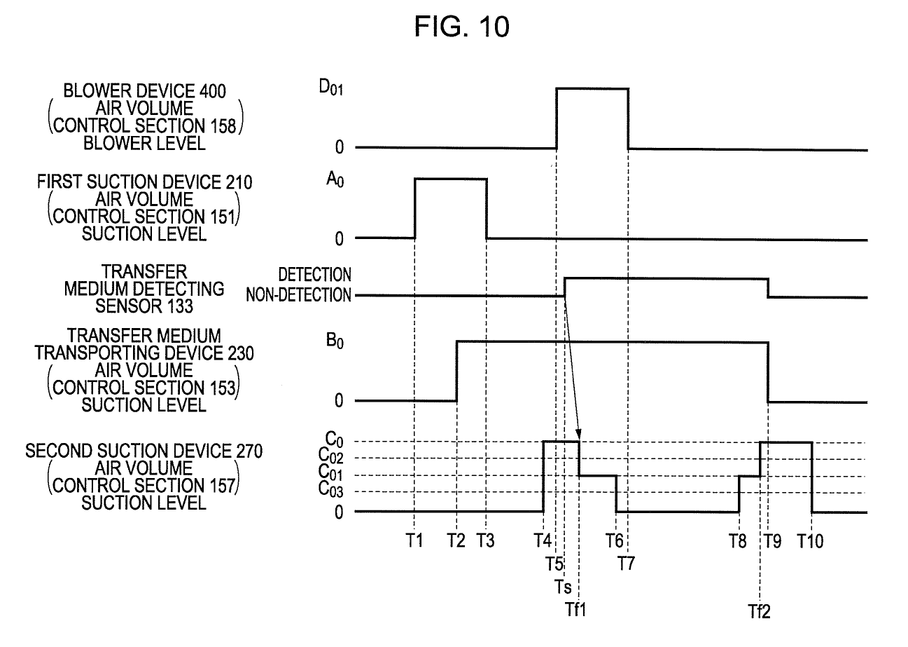

Next, an example of the control process that is more detailed than that of the image forming apparatus will be described. FIG. 10 is a diagram showing an example of the control sequences performed by control blocks of the image forming apparatus according to an embodiment of the invention. In the control sequence diagrams described below, C₀ is a predetermined suction level satisfying the relationship of C₀>C₀₂.

In FIG. 10, the first level represents the operation sequence of the blowing level of the blower device 400 (the air volume control section 158). In addition, the second level represents the operation sequence of the suction level of the first suction device 210 (the air volume control section 151). The third level represents the operation sequence of the suction level of the transfer medium transporting device 230 (the air volume control section 153). The fourth level represents the operation sequence of the suction level of the second suction device 270 (the air volume control section 157).

At time T1 when the front end portion (S₀) of the transfer medium S in the transport direction is discharged from the nip portion of the secondary transfer unit 60. And before the transfer medium S arrives at the first suction device 210, the first suction device 210 is turned on. Then, at time T2 before the front end portion (S₀) of the transfer medium S in the transport direction arrives at the transfer medium transporting device 230, the transfer medium transporting device 230 is turned on. At time T3 after the front end portion (S₀) of the transfer medium S in the transport direction passes through the first suction device 210, the first suction device 210 is turned off. While the transfer medium S passes through the first suction device 210, the first suction device 210 is turned off. However, the transfer medium S is held in the nip of the secondary transfer unit 60 and is held by the suction force of the transfer medium transporting device 230, and accordingly, the transfer medium S does not drop.

At time T4 before the front end portion (S₀) of the transfer medium S in the transport direction arrives at the second suction device 270, the second suction device 270 is turned on. When passing of the front end portion (S₀) of the transfer medium S in the transport direction below the second suction device 270 is detected by the transfer medium detecting sensor 133, at time Tf1 after a predetermined time elapses, the front end portion (S₀) of the transfer medium S in the transport direction arrives at the nip of the fixing unit 90. At that timing, the suction force of the airflow generating unit 275 is controlled to be as shown in FIG. 9 in response to the type of the transfer medium that is stored in the transfer medium type information storing unit 145. Then, at time T6 when the front end portion (S₀) of the transfer medium S in the transport direction completes the passing, the second suction device 270 is turned off.

In addition, before and after the rear end portion (S_{E}) of the transfer medium S in the transport direction is discharged from the nip portion of the secondary transfer unit 60, the blower device 400 is turned on for a predetermined time from time T5 to time T7. Accordingly, the airflow for controlling the orientation of the transfer medium S is discharged near the rear end portion (S_{E}) in the transport direction from the blower device 400. Therefore, the orientation of the transfer medium S is stabilized, and there is no possibility of defacing the surface (print surface) onto which an image is transferred. In addition, deterioration of the image quality due to the defacement of the image can be suppressed.

At time T8 before the rear end portion (S_{E}) of the transfer medium S in the transport direction arrives at the second suction device 270, the second suction device 270 is turned on. The suction level of the second suction device 270 at this time is controlled to be as shown in FIG. 9. Then, at time Tf2 prior to completion of passing of the rear end portion (S_{E}) of the transfer medium S in the transport direction through the transfer medium transporting device 230, the suction level of the second suction device 270 is returned to C₀. Then, at time T10 when the rear end portion (S_{E}) of the transfer medium S in the transport direction completes the passing, the second suction device 270 is turned off.

As described above, according to the image forming apparatus according to an embodiment of the invention, a negative effect accompanied with transport of the transfer medium transporting unit does not occur in the fixing process of the fixing unit 90. Accordingly, defective fixing and deterioration of the image quality can be suppressed.

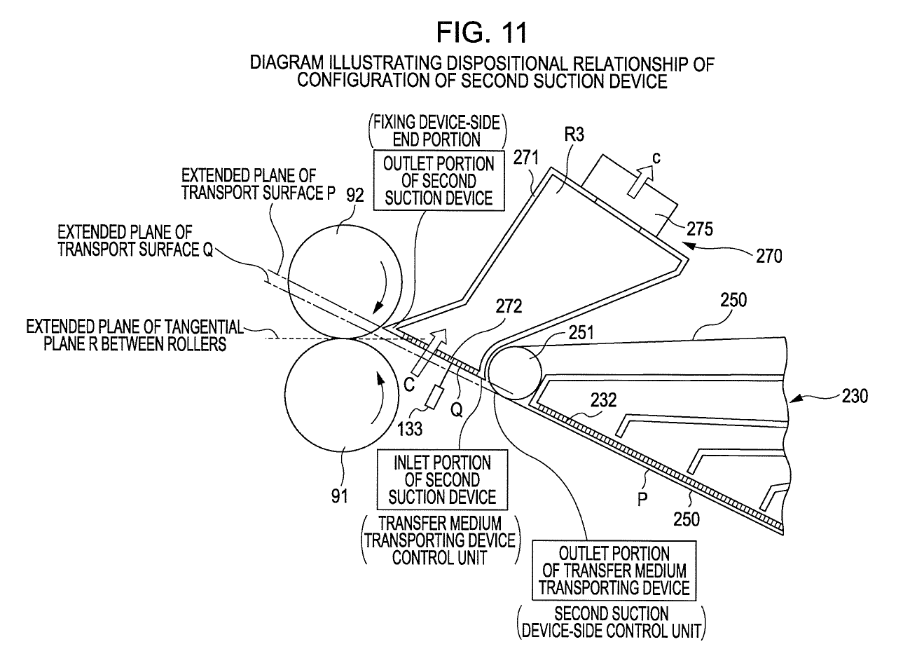

Next, preferred dispositional relationship between the transfer medium transporting unit and the fixing unit 90 will be described with reference to FIG. 11. FIG. 11 is a diagram illustrating the dispositional relationship of constituent members relating to the second suction device 270.

As shown in FIG. 11, the end portion of the second suction device 270 that is located on the fixing unit 90 side is disposed so as to be positioned above both imaginary planes in the vertical direction including an imaginary extended plane of the transport surface P that is used for transporting the transfer medium by the transfer medium transporting device 230 and an imaginary extended plane of a tangent plane R formed by the heating roller 91 and the pressing roller 92. By forming such dispositional relationship, even a transfer medium S on which upward protruded curling is formed can be easily sucked into the nip between the heating roller 91 and the pressing roller 92.

In addition, as shown in FIG. 11, the dispositional relationship in which the end portion of the transfer medium transporting device 230 of the second suction device 270 is positioned above an imaginary extended plane of the transport surface P in the vertical direction that is used for transporting the transfer medium by the transfer medium transporting device 230 is formed. Thus, even a transfer medium S on which upward protruded curling is formed can be smoothly delivered from the transfer medium transporting device 230 to the second suction device 270.

As described above, according to the image forming apparatus and the image forming method of an embodiment of the invention, uplift of the transfer medium due to curling of the transfer medium can be prevented when the transfer medium is transported. Accordingly, jamming does not occur due to the transfer medium dropping out from the transport belt (transfer medium transporting member), and deterioration of the image quality caused by defective fixing due to misleading of the transfer medium to a predetermined position of the fixing unit does not occur.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image forming apparatus comprising:
a transfer belt onto which an image is transferred;
a roller around which the transfer belt is wound;
a transfer roller that sandwiches the transfer belt with the roller, that is arranged to form a transfer nip, and that transfers the image from the transfer belt to a transfer medium passing through the transfer nip;
a transfer medium transporting unit that vertically upwardly sucks the transfer medium to which the image is transferred, and that transports the transfer medium with the image facing vertically down;
a guide that vertically upwardly sucks the transfer medium transported by the transfer medium transporting unit; and
a fixing unit that has a heating roller and a pressing roller to form a fixing nip, and that fixes the image to the transfer medium guided by the guide at the fixing nip.

2. The image forming apparatus according to claim 1, wherein
the guide includes a first end portion that is located closer to the fixing unit than to the transfer medium transporting unit and that is arranged in a vertically upper side of a first imaginary plane extended from a transfer plane on which the transfer medium is transported by the transfer medium transporting unit and a second imaginary plane extended from the fixing nip.

3. The image forming apparatus according to claim 2, wherein
the guide includes a second end portion that is located closer to the transfer medium transporting unit than to the fixing unit and is arranged in the vertically upper side of the first imaginary plane.

4. The image forming apparatus according to claim 1, further comprising
an airflow generating unit that generates an airflow for sucking the transfer medium to the upper side in the vertical direction, and
a control unit that controls the airflow, and that changes the airflow when the transfer medium arrives at the fixing nip.

5. The image forming apparatus according to claim 4, wherein
the control unit changes the airflow after the transfer medium passes through the transfer medium transporting unit.

6. An image forming method comprising:
transferring an image onto a transfer belt;
transferring the image from the transfer belt to a transfer medium;
transporting the transfer medium by a transfer medium transporting unit while vertically upwardly sucking the transfer medium to which the image is transferred;
guiding the transfer medium transported by the transfer medium transporting unit to a fixing nip, the fixing nip that is formed by a heating roller and a pressing roller while vertically upwardly sucking the transfer medium; and
fixing the image to the transfer medium in the fixing nip.
